(19) United States
(12) Patent Application Publication
(10) Pub. No.: US 2010/0050874 A1
(43) Pub. Date: Mar. 4, 2010

(54) Exhaust after treatment system and method

(76) Inventors: Walter Cullen Lucas, Addison, NY (US); Joel Andrew Schultes, Corning, NY (US)

Correspondence Address: CORNING INCORPORATED, SP-TI-3-1, CORNING, NY, 14831, US

(21) Appl. No.: 12/231,143

(22) Filed: Aug. 29, 2008

(51) Int. Cl. B01D 51/00; B01D 50/00; B01D 46/00; B32B 3/12

(52) U.S. Cl. 95/287; 55/318; 55/315.2; 428/116; 55/419; 55/418.1

(57) ABSTRACT

An exhaust after treatment system includes a wall-flow particulate filter and a flow-through substrate positioned upstream of the filter. The substrate has a plurality of channels defining a mean channel length, a first flow-through region including a first portion of the channels, and a second flow-through region including a second portion of the channels. The first flow-through region includes unplugged channels having lengths less than the mean channel length and the second flow-through region includes unplugged channels having lengths greater than the mean channel length.

### BACKGROUND

The present invention relates generally to systems and methods for purifying exhaust gases from internal combustion engines. More specifically, the invention relates to methods and systems including combinations of flow-through substrates and wall-flow particulate filters.

Combustion of fuel produces particulates such as soot. These particulates are in addition to traditional fuel combustion emissions such as carbon monoxide, hydrocarbons, and nitrogen oxides. Wall-flow particulate filters are often used in engine systems to remove particulates from the exhaust gas. These wall-flow particulate filters are typically made of a honeycomb-like substrate with parallel flow channels or cells separated by internal porous walls. Inlet and outlet ends of the flow channels are selectively plugged, such as in a checkerboard pattern, so that exhaust gas, once inside the substrate, is forced to pass through the internal porous walls, whereby the porous walls retain a portion of the particulates in the exhaust gas.

In this manner, wall-flow particulate filters have been found to be effective in removing particulates from exhaust gas. However, the pressure drop across the wall-flow particulate filter increases as the amount of particulates trapped on and with the porous walls increases. The increasing pressure drop results in a gradual rise in back pressure against the engine, and a corresponding decrease in the performance of the engine. When the pressure drop across the particulate filter reaches a certain level, the filter may be thermally regenerated in-situ.

Thermal regeneration involves subjecting the particulate filter to a temperature sufficient to fully combust particulates such as soot trapped in the filter, thereby reducing the pressure drop across the filter. In some instances, only partial regeneration of the filter occurs, such that a residual amount of trapped soot remains at the outer periphery of the wall-flow filter element due to inadequate heating in this region. Inadequate heating at the outer periphery of the wall-flow filter may result from, for example, heat loss to the environment and/or inadequate exhaust gas flow (and its associated thermal energy) to the periphery of the filter.

Residual soot in the filter has several undesirable effects, such as inefficient use of regeneration energy, loss of filter capacity, and increased backpressure of the filter during operation. In addition, as residual soot is allowed to concentrate at the periphery of the filter substrate over sequential regeneration cycles, the soot in that region may reach a critical concentration, thereby allowing it to regenerate in a manner that causes excessive temperature spikes within the filter substrate. Excessive temperature spikes may produce thermal stress in the structure of the particulate filter. If the thermal stress exceeds the mechanical strength of the particulate filter, the filter may crack, which may, in some cases, degrade performance and/or life of the filter. Therefore, means of better controlling the soot distribution and thermal energy distribution in the wall-flow particulate filter is desirable.

### SUMMARY

In one broad aspect, embodiments according to the invention provide an exhaust after treatment system comprising a wall-flow particulate filter, and a flow-through substrate positioned upstream of the wall-flow particulate filter, the flow-through substrate having an inlet face and an outlet face and a plurality of channels extending between the inlet face and the outlet face, the plurality of channels defining a mean channel length, the flow-through substrate having a first flow-through region including a first portion of the channels and a second flow-through region including a second portion of the channels, wherein the first flow-through region includes unplugged channels having lengths less than the mean channel length and the second flow-through region includes unplugged channels having lengths greater than the mean channel length, wherein at least one of the inlet face and outlet face possess a non-planar contour.

In another broad aspect, embodiments according to the invention provide a method of purifying exhaust gas from an internal combustion engine, the method comprising the steps of: directing an exhaust gas at an inlet face of a flow-through substrate having a plurality of channels, wherein the exhaust gas is presented to the inlet face with a first flow distribution and emerges at an outlet face of the flow-through substrate with a second flow distribution that is different than the first flow distribution, wherein at least one of the inlet face and the outlet face of the flow-through substrate is non-planar; and passing the exhaust gas with the second flow distribution through a wall-flow particulate filter in-line with the flow-through substrate.

In yet another broad aspect, embodiments according to the invention provide a flow-through honeycomb substrate, comprising a honeycomb structure having an inlet face and an outlet face and a plurality of longitudinal walls extending between the inlet face and the outlet face, the longitudinal walls defining a plurality of parallel channels extending between the inlet face and the outlet face, the plurality of channels each having a channel length, wherein at least one of the inlet face and the outlet face are contoured to provide a range of channel lengths.

Other features and advantages of the invention will be apparent from the following description and the appended claims.

### BRIEF DESCRIPTION OF THE DRAWINGS

The accompanying drawings, described below, illustrate typical embodiments of the invention and are not to be considered limiting of the scope of the invention, for the invention may admit to other equally effective embodiments. The figures are not necessarily to scale, and certain features and certain view of the figures may be shown exaggerated in scale or in schematic in the interest of clarity and conciseness.

FIGS. 1A and 1B depict cross sectional views of two embodiments of flow-through honeycomb substrates in an exhaust system.

FIG. 2A is a perspective view of the flow-through honeycomb substrate depicted in FIG. 1A and illustrating a curvilinear inlet face symmetrically positioned with respect to a central axis of the substrate.

FIG. 2B is a vertical cross-section of the flow-through honeycomb substrate depicted in FIG. 2A.

FIG. 2C is a perspective view of the flow-through honeycomb substrate depicted in FIG. 1B and illustrating a curvilinear inlet face asymmetrically positioned with respect to a central axis of the substrate.

FIG. 3 is a perspective view of a wall-flow particulate filter illustrating plugged channels in at least one end.

FIG. 4A-4C are graphical depictions of various non-uniform flow velocity profiles produced by the present invention at the exit of the flow-through honeycomb substrate.

FIG. 5A-5E are views of flow-through honeycomb substrates illustrating various inlet and outlet face profiles according to embodiments of the present invention.

FIGS. 6 and 7 are side view diagrams of exhaust after-treatment systems including the combination of a [domed configuration] flow-through honeycomb substrate and wall-flow filter of the invention.

### DETAILED DESCRIPTION

The invention will now be described in detail with reference to exemplary embodiments illustrated in the accompanying drawings. In describing the exemplary embodiments, numerous specific details are set forth in order to provide a thorough understanding of the invention as set forth in the accompanying claims. However, it will be apparent to one skilled in the art that the invention may be practiced without some or all of these specific details. In other instances, well-known features and/or process steps have not been described in detail so as not to unnecessarily obscure the invention. In addition, like or identical reference numerals are used to identify common or similar elements.

According to embodiments described herein, the invention provides a flow-through substrate having a honeycomb-like structure with longitudinally-oriented through-channels or cells of different lengths for passage of exhaust gas therethrough. During engine operation, exhaust gas approaches and is presented to the inlet face of the flow-through substrate with an incoming flow distribution, passes through the channels of the flow-through substrate, and exits the flow-through substrate with an outgoing flow distribution. The different lengths of the channels in the flow-through substrate present different flow resistances to the exhaust gas passing therethrough. The different flow resistances of the channels act to modify the flow distribution through the flow-through substrate (as compared to a flow-through substrate having channels of equal length) such that the outgoing flow distribution is different than the incoming flow distribution. In particular, the channel lengths are designed and positioned to provide an outgoing flow distribution that provides a desired soot distribution and/or desired thermal energy distribution to a filter element downstream from the flow-through substrate. In one embodiment, the desired soot and/or thermal energy distributions in the filter element may be achieved by a uniform outgoing flow distribution. In another embodiment, the desired soot and thermal energy distributions may be achieved by a non-uniform outgoing flow distribution.

In an exhaust system including a wall-flow particulate filter, the flow-through substrate may be positioned upstream of the wall-flow particulate filter and may be used to generate and provide a desired soot distribution and/or desired thermal energy distribution to the inlet of the wall-flow particulate filter. The desired soot distribution and desired thermal energy distribution can produce a thermal profile in the wall-flow filter element which improves the regeneration efficiency of the filter element and improves (i.e., reduces) the thermal gradients within the filter. During the soot loading process, the improved thermal energy distribution may also increase passive regeneration efficiency by reducing or eliminating cold regions of the filter substrate. The improved thermal energy distribution may reduce or eliminate excessive local temperature spikes that produce differential thermal stresses in the wall-flow particulate filter during regeneration events. As noted above, such differential thermal stresses may cause internal cracking of the particulate filter. Accordingly, reductions in differential thermal stress during regeneration intervals are much sought after.

In certain embodiments, the interior surfaces of the flow-through substrate and/or the wall-flow filter may include active catalytic species. In particular, the catalysts may be oxidation catalysts comprising a platinum group metal(s) dispersed on a ceramic support in order to convert both HC and CO gaseous pollutants and particulates, i.e., soot particles, by catalyzing the oxidation of these pollutants to carbon dioxide and water. Such catalysts have generally been contained in the exhaust system of internal combustion power systems to treat the exhaust before it vents to the atmosphere.

In embodiments according to the invention, thermal energy is transferred to the filter element during soot loading and during regeneration, through convection (provided by heat-carrying exhaust gas entering the filter) and chemical energy (provided by the exothermic conversion of CO, HC to CO₂ and H₂O in the catalyzed flow-through substrate and/or catalyzed filter substrate). During the regeneration cycle, additional hydrocarbons may be added to the exhaust stream to be oxidized (either in the catalyzed flow-through substrate or filter element) to produce additional heating to enable the oxidation of carbonaceous soot and other organics which are trapped in the filter element.

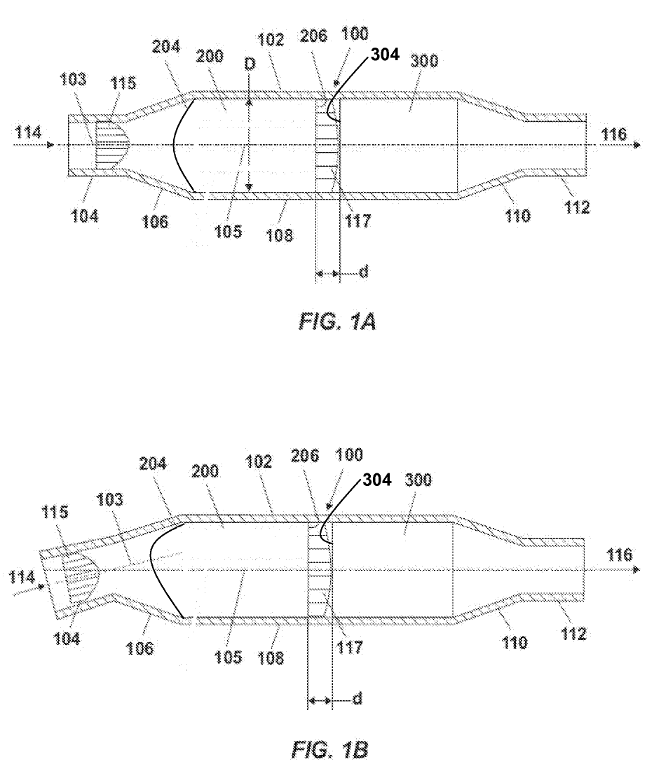

FIGS. 1A and 1B schematically depict an exhaust after treatment system 100 for processing and venting exhaust gas from an internal combustion engine (not shown) according to aspects of the invention. The exhaust after treatment system 100 includes a housing 102 that, in one embodiment, is manufactured from a metal, such as steel. In one example, the housing 102 includes an inlet section 104 adapted to interconnect to the engine (not shown), an optional diffuser section 106, a purification section 108, an optional converging section 110, and an outlet section 112, which may be optionally interconnected to a tailpipe (not shown). The exhaust after treatment system 100 includes therein a flow-through substrate 200 having non-uniform channel lengths and a wall-flow particulate filter 300, arranged in series orientation. The substrate 200 and the filter 300 are arranged, in an end to end configuration, in the housing 102 and, in one embodiment, are disposed in the purification section 108. The substrate 200 and filter 300 may be mounted within housing 102 using a mat system (not shown), such as a vermiculite based intumescent mat or a alumina fiber-based non-intumescent mat.

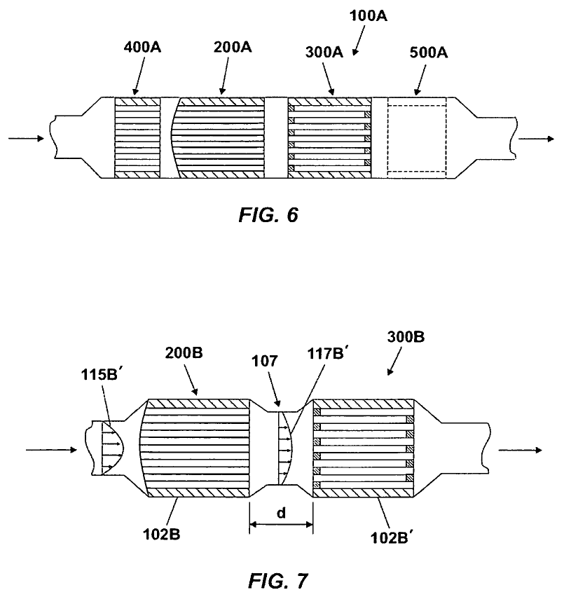

An optional exhaust system 100A, such as shown in FIG. 6, may include other devices in addition to the flow through substrate 200A and wall-flow filter 300A which assist in purification of exhaust gas. For example, where the flow-through substrate 200A does not incorporate active catalytic species, one or more oxidation catalysts 400A may precede the flow-through substrate 200A. In other exhaust after treatment systems, an oxidation catalyst 500A, such as a lean nitrogen oxide (NOₓ) catalyst or an SCR catalyst, may follow the wall-flow particulate filter 300A.

Within the exhaust system, the flow-through substrate 200 and wall-flow particulate filter 300 may be either aligned or misaligned. For example, in FIG. 1A, the longitudinal axis 103 of the inlet section 104 is aligned or substantially aligned with the longitudinal axis 105 of the purification section 108. In FIG. 1B, the longitudinal axis 103 of the inlet section 104 is inclined at an angle to the longitudinal axis 105 of the purification section 108.

In FIGS. 1A and 1B, the flow-through substrate 200 immediately precedes the wall-flow particulate filter 300 and the longitudinal axis of the flow-through substrate 200 is aligned or substantially aligned with the longitudinal axis of the wall-flow particulate filter 300. In addition, the flow-through substrate 200 may be spaced apart longitudinally from the wall-flow particulate filter 300 such that the respective outlet face of the flow through substrate 200 is spaced from the inlet face 304 of the filter 300.

Preferably, the spacing (d) between the opposing faces 206, 304 of the flow-through substrate 200 and the wall-flow particulate filter 300 is not so large that the flow profile 117 exiting the flow-through substrate 200 has a chance to significantly change (due to, e.g., laminar pipe flow) prior to entering the wall-flow particulate filter 300. In one example, the spacing (d) is less than about 15 cm. In another example, the spacing (d) is less than about 8 cm. In yet another example, the spacing (d) is less than (D), the largest diameter of the flow through substrate 200, i.e., d<D. As is shown in FIG. 7, the flow-through substrate 200B and the filter 300B may be included in separate housings 102B, 102B′ interconnected by a smaller-dimension transition section 107 so long as the spacing (d) is sufficiently short such that the benefit of the modified flow profile is not lost. In other words, the flow profile 117B′ is substantially different from flow profile 115B′ and creates the desired soot distribution and/or desired thermal energy distribution for filter 300.

Again referring to FIG. 1A, the diameter of the flow-through substrate 200 may be the same as, larger than, or smaller than, the diameter of the wall-flow particulate filter 300. Both the flow-through substrate 200 and the wall-flow particulate filter 300 include honeycomb-like substrates having longitudinally extending channels or cells, as will be further explained below. The cell densities of the flow-through substrate 200 and the wall-flow particulate filter 300 may or may not be the same, where cell density is the number of channels per cross-sectional area of the honeycomb substrate.

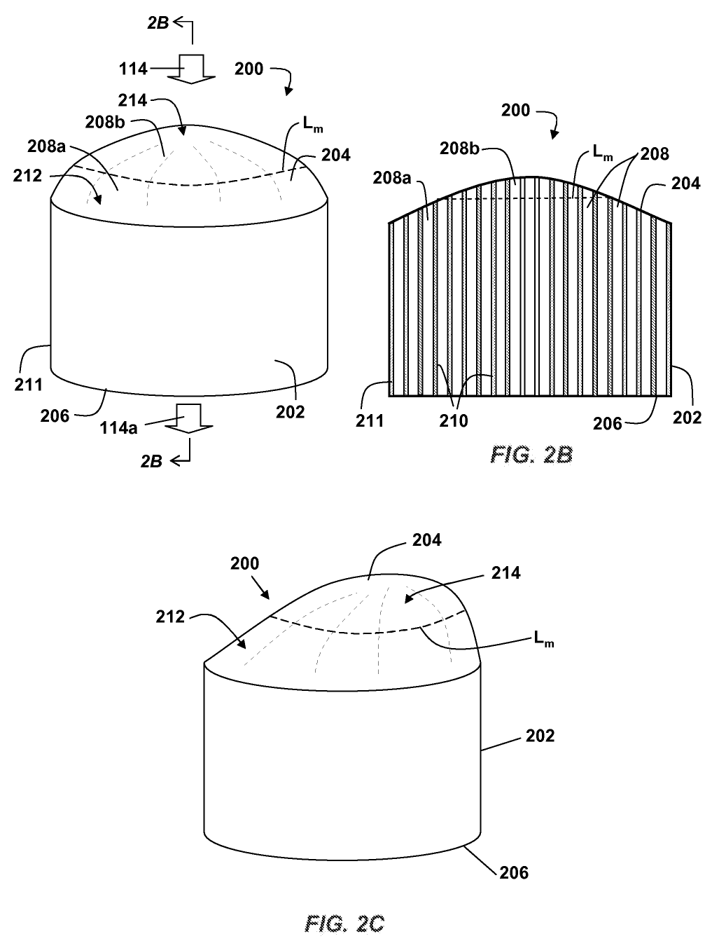

FIGS. 2A and 2B depict the flow-through substrate 200 in perspective view and cross-sectional view, respectively. The flow-through substrate 200 includes a honeycomb-like substrate structure 202, which may be made by extrusion, for example, using any known plasticized ceramic precursor materials. Upon firing of the extruded body, a ceramic such as, for example, cordierite, aluminum titanate, or silicon carbide, is formed. Although not shown, the substrate structure 202 may be disposed within a metal sleeve prior to inserting the flow-through honeycomb substrate 200 in the housing (102 in FIG. 1A or 1B) and may also be encircled by a resilient intumescent mat sandwiched between the skin 211 and the sleeve, as discussed above. The honeycomb substrate structure 202 may be substantially columnar in shape. The traverse cross-sectional shape of the honeycomb structure 202 may be circular, elliptical, square, rectangular or may have other suitable geometrical shape for the application. The honeycomb substrate structure 202 has an inlet face 204 and an outlet face 206, where the inlet face 204 opposes the outlet face 206 and has parallel channels 208 extending from the inlet face 204 to the outlet face 206 along the longitudinal length thereof. The channels 208 are defined by a plurality of intersecting longitudinal cell walls 210 extending from the inlet face 204 to the outlet face 206. The plurality of channels 208 have a mean channel length (schematically represented by line Lₘ). At least one of the inlet face 204 and the outlet face 206 are contoured or shaped such that a first portion 208a of channels 208 have lengths less the mean channel length Lₘ, and a second portion 208b of channels 208 have lengths greater than the mean channel length Lₘ. In one embodiment, at least one of inlet face 204 and outlet face 206 is provided with a nonplanar profile.

Exhaust gas flow 114 having a first flow distribution 115 (with an associated soot distribution and thermal energy distribution) is received at the inlet face 204. The exhaust gas flow 114 passes through the substrate 200 via the channels 208 to the outlet face 206. The non-uniform lengths of the channels 208 present non-uniform flow resistance to exhaust gas flow 114, and thereby alter or modify the flow distribution 115 of exhaust flow 114 (as compared to a flow-through substrate having equal length channels). The altered or modified exhaust gas flow 114a has a second flow distribution 117 (with an associated soot distribution and thermal energy distribution) different from first flow distribution 115. Exhaust gas flow 114a having second flow distribution 117 thus exits the honeycomb substrate 200 through the outlet face 206. As will be described in further detail below, the second flow distribution 117 is tailored to provide a desired soot distribution and/or thermal energy distribution to filter 300. In one embodiment, the second flow distribution optimizes the regeneration efficiency of filter 300.

The intersecting walls 210 of the honeycomb substrate 202 defining the channels 208 are porous, and exemplary embodiments exhibit a total porosity of less than about 65%, or even between about 20% and 55%, or even between 25% and 40%. Mean pore size of the walls may be between 1 μm and 15 μm, or even between 5 μm and 10 μm. The coefficient of thermal expansion (CTE) is, in one embodiment, between 1.0×10⁻⁷/° C. up to about 9×10⁻⁷/C measured between 25° C. and 800° C. In another embodiment, the CTE is greater than about 9×10⁻⁷/° C. measured between 25° C. and 800° C. The walls 210 may or may not carry active catalytic species, such as oxidation catalytic species. Where the walls 210 carry active catalytic species, the active catalytic species may be provided in a porous wash coat applied on the walls 210 or otherwise incorporated on the walls 210. Where wash coated, the wash coat may include a material such as alumina, zirconia, or ceria. The flow-through substrate 200 may incorporate any known active catalytic species for purifying exhaust gas, such as oxidation catalytic species for reducing the quantities of carbon monoxide, hydrocarbons, and soluble organic fraction of particulates in the exhaust gas. The catalyst can be any type of oxidation catalyst, including PGM (mainly Pt, Pd, Rh or RuO₂) or other types of mixed oxide catalysts, such as perovskite, oxygen storage materials, and supported metal catalysts.

The flow-through substrate 200 includes a first flow-through region 212 (corresponding to first portion 208a of channels 208) and a second flow-through region 214 (corresponding to second portion 208b of channels 208). In one embodiment, none of the channels 208 are plugged in the first and second flow-through regions 212, 214, and exhaust gas passes straight through the unplugged channels. The longer channels of second portion 208b have the effect of increasing flow resistance in the second flow-through region 214 (or conversely, the shorter channels of first portion 208a have the effect of decreasing flow resistance in the first flow-through region 212). This differential flow resistance is tailored to redirect exhaust flow 114 from the second flow-through region 214 to and through the first flow-through region 212 in a desired manner. Accordingly, this modifies the flow distribution 115 entering flow-through honeycomb substrate 200 to create the desired flow distribution 117 exiting the substrate 200. This may be used to produce desired (i.e., optimized) soot and/or thermal energy distributions to the inlet face 304 of filter 300.

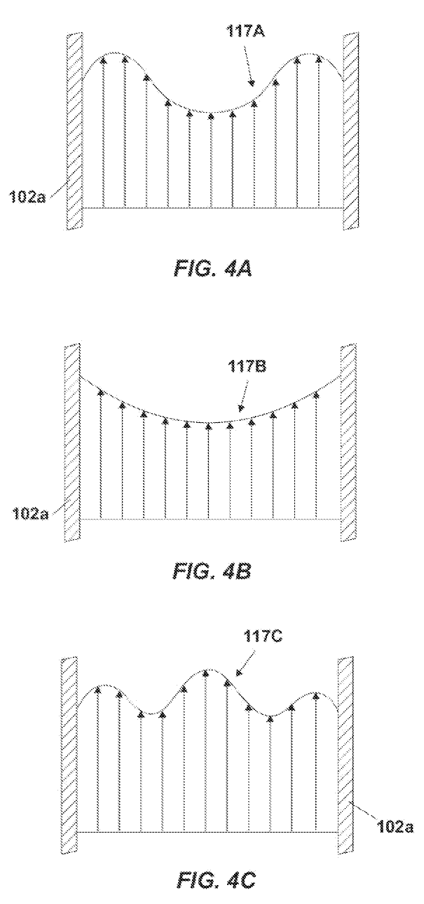

FIGS. 1A and 1B show the initial flow distribution 115 passing through the inlet section 104 to the inlet face 204 of the flow-through honeycomb substrate 200 and the modified flow distribution 117 emerging at the outlet face 206 of the flow-through honeycomb substrate 200 as a result of the non-uniform channel lengths in substrate 200. In this embodiment, the second flow-through region 214 is located in the substrate 200 where the maximum amplitude of the incoming flow distribution 115 would impinge on the inlet face 204 of the flow-through honeycomb substrate 200. The flow distribution 115 (and also flow distribution 117) may correlate to, for example, velocity, soot volume, thermal energy, etc., of exhaust flows 114, 114a. Embodiments according to the invention may use various non-uniform channel length patterns on the flow-through honeycomb substrate 200 to effectuate various desirable exit flow distributions 117, for example the exit flow distributions 1171-117C as shown in FIG. 4A-4C.

Returning to FIG. 2A, within the first and second flow-through regions 212, 214, the lengths of the channels 208 may vary and depend upon the flow distribution 115 of the flow impinging on the inlet face 204 of the honeycomb substrate 202 and also the flow distribution 117 required to produce a desired (i.e., optimized) soot and/or thermal energy distribution at the inlet 304 of filter 300. The location of the second flow-through region 214 in the honeycomb substrate 202 can also be variable, its location depending upon the flow distribution 115 impinging on the inlet face 204 of the honeycomb substrate 202 and the flow distribution 117 required to produce a desired soot and/or thermal energy distribution to the inlet 304 of filter 300. In general, flow modeling may be used to determine the incoming flow distribution 115, the optimum exiting flow distribution 117, the optimum maximum and minimum channel lengths, and the optimum distribution of channel lengths in the flow-through honeycomb substrate 200. Depending upon the incoming flow distribution 115 and the desired outgoing flow distribution 117, the flow-through honeycomb substrate 200 may include more than one region of increased (or decreased) channel length to achieve the desired flow distribution 117.

Two different exemplary locations of the second flow-through region 214 are illustrated in FIGS. 2A and 2C. In FIG. 2A, the center of the flow-through region 214 coincides with, and is substantially centrally oriented with respect to, the central axis of the honeycomb substrate 202. In contrast, in FIG. 2C, the center of the flow-through region 214 is offset from the central axis of the honeycomb substrate 202. Of course, first and second flow-through regions 212, 214 that are shaped and configured differently from those illustrated may be provided.

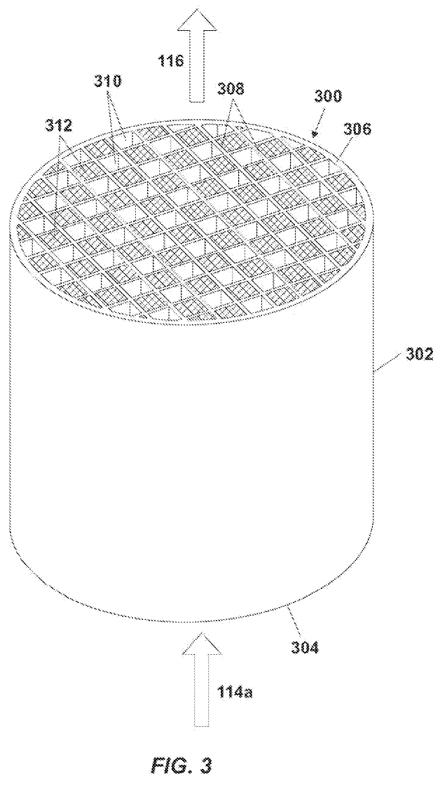

In the system 100, the wall-flow particulate filter (300 in FIG. 1A or 1B) can be of any conventional construction. For example, as shown in FIG. 3, the wall-flow particulate filter 300 may have a honeycomb structure 302 with opposite end faces 304, 306 and interior porous walls 308 extending between the end faces 304, 306, where the interior porous walls 308 define parallel channels 310 within the honeycomb structure 302. The channels 310 may be end-plugged with filler material 312 in a checkerboard pattern on the end faces 304, 306. In one embodiment, the wall-flow particulate filter 300 does not have unplugged channels as in the case of the flow-through monolith (200 in FIGS. 2A-2C) because unplugged channels in the wall-flow particulate filter would allow exhaust gas to escape without being filtered.

The honeycomb structure 302 of the filter may be made by extrusion from, for example, ceramic batch precursors and forming aids and fired to produce ceramic honeycombs of cordierite, aluminum titanate, or silicon carbide. The plugging material 312 for plugging the channels 310 may also include any suitable ceramic forming material, such as a cordierite- or aluminum titanate-based composition with CTE generally closely matched to the CTE of the honeycomb structure. Exemplary plugging materials are taught and described in U.S. patent application Ser. No. 11/486,699 dated Jul. 14, 2006 and entitled “Plugging Material For Aluminum Titanate Ceramic Wall Flow Filter Manufacture,” WO 2005/051859, WO/074599, U.S. Pat. No. 6,809,139, and U.S. Pat. No. 4,455,180, for example. For passive regeneration, the porous walls 308 of the filter may include active catalytic species. Further, an oxidative catalyst, such as a lean NOₓ catalyst 500A, may be added to the system at one of the end faces of the wall-flow particulate filter 300A such as shown in FIG. 6.

In one embodiment, the porous walls 308 of the filter 300 may incorporate pores having mean diameters in the range of 1 to 60 μm, more typically in the range of 10 to 50 μm, or even 10 to 25 μm, and the honeycomb substrate 302 may have a cell density between approximately 10 and 900 cells/in² (1.5 and 135 cells/cm²), more typically between approximately 100 and 600 cells/in (15.5 and 93 cells/cm²). The thickness of the porous walls 308 may range from approximately 0.002 in. to 0.060 in. (0.05 mm to 1.5 mm), more typically between approximately 0.010 in. and 0.030 in. (0.25 mm and 0.76 mm). The channels 310 may have a square cross-section or other type of cross-section, e.g., triangle, rectangle, octagon, hexagon or combinations thereof.

Returning to FIG. 1A or 1B, in operation exhaust gas 114 from an internal combustion engine, for example, a gasoline engine or a diesel engine, is received in the inlet section 104. The exhaust gas 114 passes through the inlet section 104 with an initial flow distribution 115 (e.g., a soot distribution and/or a thermal energy distribution), passes through the diffuser section 106, and enters the flow-through substrate 200. In embodiments where the flow-through substrate 200 includes active catalytic species, various oxidation processes may occur while the exhaust gas 114 flows through the flow-through substrate 200. The exhaust gas 114 exits the flow-through substrate 200 with a flow distribution 117 (e.g., a soot distribution and/or a thermal energy distribution) which is modified from when it entered the flow-through substrate 200, and which is more desirable for managing the soot distribution and/or thermal energy distribution of the wall-flow particulate filter 300. In one embodiment, flow distribution 117 is more uniform than flow distribution 115. The exhaust gas 114a with the modified and more desirable flow distribution 117 enters the wall-flow particulate filter 300 and is forced through the interior porous walls in the wall-flow particulate filter 300. A portion of the particulates in the exhaust gas 114 is trapped on or within the porous walls. The filtered exhaust gas 116 exits the wall-flow particulate filter 300, passes through the converging section 110, and exits the exhaust system 100 through the outlet section 112.

As shown in FIGS. 4A-4C, non-uniform flow distributions 117A-117C (e.g., soot distributions, thermal energy distributions, velocity distributions, etc.) may result from the non-uniform length channels in the flow-through honeycomb substrate 200. FIG. 4A and FIG. 4B illustrate flow distributions 117A, 117B where the flow distribution at the centermost portion is less than at other points in the profile, for example. FIG. 4A illustrates a distribution 117A with a peak located neither at the wall 102a of the exhaust pipe 102 or at the centerline thereof. Similarly, FIG. 4B illustrates a flow distribution 117B where the maximum is not at the centerline of the exhaust pipe, but is adjacent the outer wall 102a. FIG. 4C illustrates a flow distribution 117C where the minimum occurs in an intermediate region between the center and the wall 102a. These and other exemplary flow distributions 117 may be created to provide optimized, or at least improved, soot and/or thermal energy distributions within filter 300.

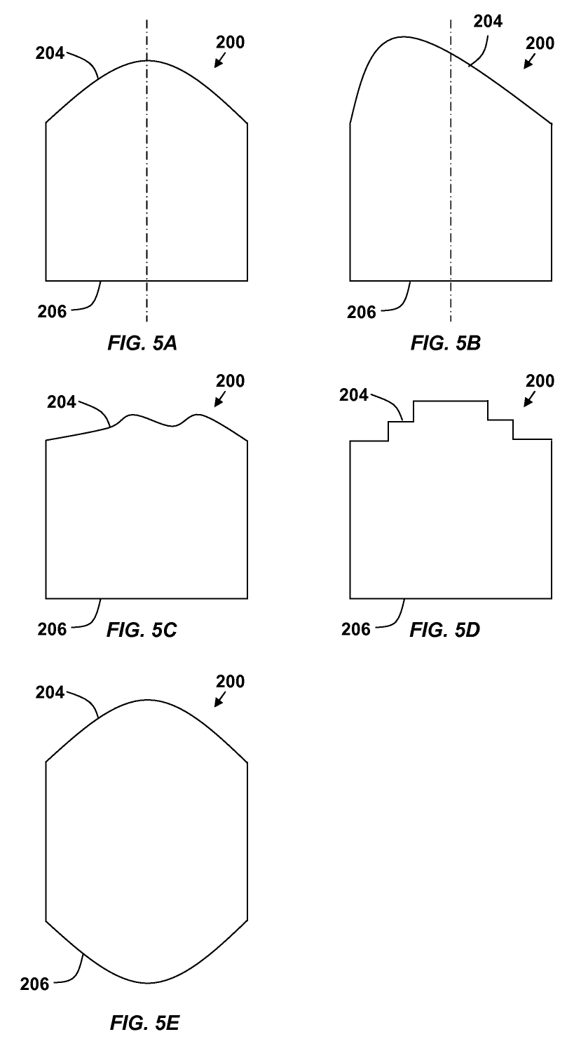

FIGS. 5A-5E illustrate various nonplanar profiles of inlet face 204 and/or outlet face 206 which result in a modified flow distribution according to the invention. FIG. 5A illustrates a curvilinear inlet face 204 that is positioned substantially symmetrically with respect to the central axis of substrate 200. In one embodiment, the curvilinear inlet face 204 comprises a substantially hemispherical surface. FIG. 5B illustrates a curvilinear inlet face 204 that is not symmetrically positioned with respect to the central axis of substrate 200. FIG. 5C illustrates a curvilinear inlet face 204 having more than one region of increased channel length. FIG. 5D illustrates a stepped inlet face 204 providing three different lengths of channels 208. In various embodiments, the annular steps may be positioned substantially symmetrically or asymmetrically with respect to the central axis of substrate 200. In other embodiments, the stepped inlet face 204 may have 2, 4, 5 or more steps with a corresponding number of channel lengths. FIG. 5E illustrates both inlet face 204 and outlet face 206 having a non-planar surface. Other profiles and combinations of profiles of inlet and outlet faces 204, 206 may be employed based upon the flow dynamics of the system to accomplish the desired soot loading and thermal energy distribution within the filter 300, and thereby provide improved regeneration efficiency of the filter.

As described herein, embodiments according to the invention enable improved or optimal exhaust flow profile (and thereby improved or optimal soot distribution and associated improvements in thermal profiles) into a wall-flow filter in an exhaust gas after-treatment system, and thereby enable (through convection and/or chemical energy) optimal heat distribution for passive and active filter regeneration which produces improved regeneration efficiencies and thermal profiles. Notably, the improved efficiency of the exhaust flow profile allows for more efficient use of catalysts in the substrate 200. In particular, the improved exhaust flow profile decreasing the typically high velocities in central regions of the substrate and directs gas flow to typically underutilized peripheral regions of the substrate. Prior art devices without benefit of the invention described herein have higher local gas velocities which produce shorter residence time of exhaust gases in the catalyzed regions, thereby requiring a correspondingly higher precious metal loading to ensure catalytic conversion of undesirable species. However, the more even flow distribution with a lower maximum velocity provided by the invention enables use of less catalyst, through both a reduction in the overall available surface area of the substrate, and also through lower catalyst loadings on the remaining substrate.

While the invention has been described herein with respect to a limited number of exemplary embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An exhaust after-treatment system, comprising:
a wall-flow particulate filter, and
a flow-through substrate positioned upstream of the wall-flow particulate filter, the flow-through substrate having an inlet face and an outlet face and a plurality of channels extending between the inlet face and the outlet face, the plurality of channels defining a mean channel length, the flow-through substrate having a first flow-through region including a first portion of the channels and a second flow-through region including a second portion of the channels, wherein the first flow-through region includes unplugged channels having lengths less than the mean channel length and the second flow-through region includes unplugged channels having lengths greater than the mean channel length, wherein at least one of the inlet face and outlet face possess a non-planar contour.

2. The system of claim 1, wherein the first and second flow-through regions adjust gas flow through the substrate such that gas flow having a first flow distribution presented at the inlet face emerges at the outlet face with a second flow distribution different than the first flow distribution.

3. The system of claim 1, wherein at least one of the inlet face and the outlet face defines a nonplanar surface.

4. The system of claim 2, wherein the second flow distribution optimizes at least one of a soot distribution and a thermal energy distribution in the wall-flow particulate filter.

5. The system of claim 2, wherein the second flow distribution provides a peak flow of at least one of soot and thermal energy at a position other than at a center of the second flow distribution.

6. The system of claim 2, wherein the second flow-through region is located where a maximum flow velocity of the first flow distribution would impinge on the inlet face.

7. The system of claim 6, wherein a center of the second flow-through region coincides substantially with a central axis of the flow-through substrate.

8. The system of claim 6, wherein a center of the second flow-through region is offset from a central axis of the flow-through substrate.

9. The system of claim 1, wherein the first flow-through region further comprises an annular region outside of the second flow-through region.

10. The system of claim 1, wherein the flow-through substrate and the wall-flow particulate filter are disposed in a common exhaust housing.

11. The system of claim 1, wherein at least one of the flow-through substrate and wall-flow particulate filter are catalyzed.

12. The system of claim 1, wherein a distance (d) between the outlet face of the flow-through substrate and an inlet face of the wall-flow particulate filter is such that the second flow distribution is not substantially altered prior to being received in the wall-flow particulate filter.

13. The system of claim 1, wherein all of the channels of the flow-through substrate are unplugged.

14. The system of claim 5, wherein the second flow distribution provides a peak flow of thermal energy adjacent a periphery of the wall-flow particulate filter.

15. A method of purifying exhaust gas from an internal combustion engine, comprising the steps of:
directing an exhaust gas at an inlet face of a flow-through substrate having a plurality of channels, wherein the exhaust gas is presented to the inlet face with a first flow distribution;
altering the first flow distribution to form a second flow distribution at an outlet face of the flow-through substrate, wherein at least one of the inlet face and the outlet face of the flow-through substrate is non-planar; and
passing the exhaust gas with the second flow distribution through a wall-flow particulate filter in-line with the flow-through substrate.

16. The method of claim 15, wherein altering the first flow distribution to form the second flow distribution is accomplished by presenting the first flow distribution with a variable flow resistance at the inlet face.

17. A flow-through honeycomb substrate, comprising:
a honeycomb structure having an inlet face and an outlet face and a plurality of longitudinal walls extending between the inlet face and the outlet face, the longitudinal walls defining a plurality of parallel channels extending between the inlet face and the outlet face, the plurality of channels each having a channel length, wherein at least one of the inlet face and the outlet face are contoured to provide a range of channel lengths.

18. The flow-through honeycomb substrate of claim 17, wherein the range of channel lengths are selected to create an optimized flow distribution of an exhaust gas exiting the channels, wherein the optimized flow distribution optimizes a regeneration efficiency of a particulate filter downstream of the flow-through substrate.

19. The flow-through honeycomb substrate of claim 18, wherein the optimized flow distribution comprises at least one of an optimized soot distribution and an optimized thermal energy distribution.

20. The flow-through honeycomb substrate of claim 17, wherein the longitudinal walls include an oxidation catalyst.
